(19) United States
(12) Patent Application Publication
(10) Pub. No.: US 2015/0342225 A1
(43) Pub. Date: Dec. 3, 2015

(54) Cat Supplement Composition

(71) Applicant: Virginia Vaughn, Thompson Falls, MT (US)

(72) Inventor: Virginia Vaughn, Thompson Falls, MT (US)

(21) Appl. No.: 14/722,883

(22) Filed: May 27, 2015

Related U.S. Application Data
(60) Provisional application No. 62/003,161, filed on May 27, 2014.

(51) Int. Cl. A23K 1/18; A23K 1/10; A23K 1/16

(52) U.S. Cl. CPC A23K 1/1846; A23K 1/1603; A23K 1/103

(57) ABSTRACT

A composition and method for preparing a cat supplement is provided. The cat supplement composition is configured to improve overall health and wellbeing of a feline. The cat supplement composition consists essentially of an effective amount of fish broth and an effective amount of a plurality of vitamins and minerals. The effective amounts of the plurality of vitamins and minerals are mixed with the fish broth to form a mixture. The mixture can be orally administered through mixing with cat food or water, or it can be independently administered.

### CROSS REFERENCE TO RELATED APPLICATION

This application claims the benefit of U.S. Provisional Application No. 62/003,161 filed on May 27, 2014. The above identified patent application is herein incorporated by reference in its entirety to provide continuity of disclosure.

### BACKGROUND OF THE INVENTION

1. Field of the Invention

The present invention relates to animal food products. More specifically, the present invention pertains to a composition and method for preparing a cat supplement configured to improve overall health and wellbeing of a cat.

Vitamins and minerals are often considered vital building blocks for the health of a cat. The health of cat relies on these vitamins and minerals to produce and repair everything from skin cells to neural pathways. Therefore, it is often asserted that these vitamins and minerals are essential nutrients, which a cat requires in order to function optimally. Particularly when a cat is healing from wounds or sickness, vitamins and minerals are critical to a cat's overall health and wellbeing.

Some of the most essential vitamins and minerals include Vitamin A, Vitamin D, Vitamin B1, Vitamin B2, Vitamin B3, Vitamin B6, Calcium, Magnesium, Iron, and Potassium. Some of these vitamins and minerals are produced by a cat on its own, while other vitamins and minerals are synthesized from materials found in cat food. However, not all of these essential vitamins and minerals are found in cat food, thereby preventing a cat from ingesting a balanced and nutritious diet that is crucial to good health. Therefore, there exists a need for a supplement composition for cats that allow for the cats to easily ingest the necessary vitamins and minerals to promote overall health and wellbeing.

Therefore, the present invention provides a cat supplement composition and a method for using the same. The cat supplement composition includes an effective amount of fish broth, effective amounts of a plurality of vitamins, and effective amounts of a plurality of minerals, wherein the effective amounts of the plurality of vitamins and the plurality of minerals are mixed with the effective amount of fish broth to form a cat supplement mixture. The plurality of vitamins include Vitamin A, Vitamin D, Vitamin B1, Vitamin B2, Vitamin B3, and Vitamin B6. The plurality of minerals include Magnesium, Calcium, Iron and Potassium. The cat supplement mixture is configured to be orally administrated via mixing in cat food, mixing in water, or separately administrated. In this way, the cat supplement composition is configured to improve the overall health and wellbeing of a cat.

2. Description of the Prior Art

Compositions have been disclosed in the prior art that relate to animal food products. These include compositions that have been patented and published in patent application publications. Some of these compositions disclose an oil-in-water emulsion comprising edible fats and oils, milk protein and/or vegetable protein, an emulsifier, and water. These compositions, however, do not contain an effective amount of fish broth.

The compositions disclosed in the prior art have several known drawbacks. These compositions fail to provide a plurality of vitamins and a plurality of minerals in combination with fish broth to form a cat supplement composition. In addition, these compositions fail to provide a method for using the same to improve health and wellbeing of a cat. It is therefore submitted that the present invention is substantially divergent in design elements from the prior art, and consequently it is clear that there is a need in the art for an improvement to cat supplement compositions. In this regard, the instant invention substantially fulfills these needs.

### SUMMARY OF THE INVENTION

In view of the foregoing disadvantages inherent in the known types of cat supplement compositions now present in the prior art, the present invention provides a new and improved composition and method for preparing a cat supplement wherein the same can be utilized for improving overall health and wellbeing of a cat.

It is therefore an object of the invention to provide a new and improved cat supplement composition that has all of the advantages of the prior art and none of the disadvantages.

Another object of the present invention is to provide a new and improved cat supplement composition that includes effective amounts of a plurality of vitamins, effective amounts of a plurality of minerals and an effective amount of fish broth.

Yet another object of the present invention is to provide a new and improved cat supplement composition, wherein said plurality of vitamins include Vitamin A, Vitamin D, Vitamin B1, Vitamin B2, Vitamin B3, and Vitamin B6.

Still yet another object of the present invention is to provide a new and improved cat supplement composition, wherein said plurality of minerals include Calcium, Magnesium, Iron and Potassium.

A further object of the present invention is to provide a cat supplement composition that is configured to improve overall health and wellbeing of a cat.

Yet a further object of the present invention is to provide a cat fish composition that is orally administrated via mixing with food, mixing with water, or separately administered.

### DETAILED DESCRIPTION OF THE INVENTION

For the purposes of presenting a brief and clear description of the present invention, the preferred embodiment will be discussed as used for improving the overall health and wellbeing of a cat.

The inventive cat supplement composition comprises an effective amount of fish broth (e.g., liquid form), effective amounts of a plurality of vitamins (e.g., powdered or liquid form), and effective amounts of a plurality of minerals (e.g., powdered or liquid form), whereby a specific example is described. The composition is delivered in liquid form to a cat and is configured to enable a cat to function optimally. Vitamins and minerals listed below are composed within a specific exemplary content of the cat supplement composition, wherein those of ordinary skill in the art will readily envision other vitamins and minerals that can be added or subtracted for the purpose of improving a cat's overall health and wellbeing. These modifications and alterations are considered within the scope and spirit of this cat supplement composition.

Vitamins and minerals included within this cat supplement composition comprise: Vitamin A, Vitamin D, Vitamin B1, Vitamin B2, Vitamin B6, Calcium, Magnesium, Iron; and Potassium. Vitamin A is crucial for a strong immune system and healthy vision for felines. Vitamin A is a fat soluble vitamin, which means it gets stored in fatty tissue or the liver versus being excreted by the feline's body.

Vitamin D is vital in regulating the balance of calcium and phosphorous in a cat's body. Since Vitamin D also promotes the retention of calcium, it is important for the development and function of bones, as well as nerve and muscle control.

Vitamin B1 (thiamine) is necessary for healthy metabolism of carbohydrates as well as the maintenance of normal growth and nerve impulse. It is also a water soluble vitamin that is stored within fatty tissue or the liver of a cat.

Vitamin B2 (Riboflavin) is essential in many biochemical reactions including the production of energy from fat in a cat. This vitamin is also believed to help contribute to the quality of a cat's skin and coat, wherein a deficiency may cause changes to the skin around the eyes and the abdomen.

Vitamin B3 (Niacin) is necessary for a healthy nervous system, gastrointestinal function and skin in a cat. This vitamin is water soluble and is easily excreted through urination, and therefore, requires regular replacement to maintain adequate levels.

Vitamin B6 (Pyridoxine) is important for healthy immune function and red blood cell function. Like other water soluble vitamins aforementioned, it must be replenished daily to maintain adequate levels as it is excreted from the cat's body through urine.

Calcium is a necessary mineral for development and maintenance of healthy bones and teeth for a cat. It is also believed to play a role in blood coagulation and nervous system health. Studies have shown that a deficiency of this mineral may lead to skeletal abnormalities.

Magnesium is an important mineral for cats as its primarily functions to maintain the electrical balance across cell membranes and also in the production and elimination of the neurotransmitter acetylcholine. An imbalance of magnesium levels at the cellular level may result in muscular and cardiac abnormalities.

Iron is a critical mineral for red blood cell health and the transport of oxygenated blood through a cat's body. An iron deficiency has been shown to result in anemia in cats.

Potassium is also a critical mineral for cats in both electrical and cellular functions. Potassium is an electrolyte that aids in carrying electrical charge through a cat's body. It is believed that potassium is important in the maintenance of normalizing fluid levels within cells and is responsible for the conduction of electrical charges in the heart, nerves, and muscles of a cat.

These aforementioned vitamins and minerals are obtained as powder stock or in liquid form. In addition, these aforementioned vitamins and minerals are mixed and dissolved into fish broth to form a cat supplement mixture. An exemplary fish broth is made with fish bones, fish heads, and mirepoix (e.g., mixture of celery, onions and carrots) added in water and left to simmer over a period of time. The fish bones, fish heads, mirepoix, and other solids are then removed to yield a fish broth. It is contemplated that other fish broths that are cooked differently or include more or less ingredients are suitable.

Exemplary usage of this cat supplement composition is to administer a recommended dose of the cat supplement composition to a cat once per day. This can be effectively accomplished through mixing with cat food, mixing with water, or separately administered. An exemplary recommended dosage is orally administered in 0.5 ounce doses. Depending on the weight of a cat, recommended dosages can be increased or decreased, wherein those of ordinary skill in the art can readily identify these changes in recommended doses. Such modifications and alterations are considered within the scope of the present disclosure. Further, exemplary packaging includes a carton having an interior volume therein configured to contain the supplement composition. The exemplary packaging can also identify recommended dosage and recommended usage.

According to one embodiment of the present invention, the cat supplement composition further provides a method of improving a cat's overall health and wellbeing comprising the steps of:
(1) providing a fish broth, a plurality of vitamins and a plurality minerals;
(2) mixing said plurality of vitamins and said plurality of minerals into said fish broth to form the cat supplement composition; and
(3) orally administering effective doses of the cat supplement composition to a cat.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method for improving a cat's overall health and wellbeing, comprising the steps of:
providing a fish broth, a plurality of vitamins and a plurality of minerals;
mixing said plurality of vitamins and said plurality of minerals into said fish broth to form a cat supplement composition;
orally administering effective doses of the cat supplement composition to a cat.

2. The method of claim 1, wherein said plurality of vitamins are selected from a group consisting of Vitamin A, Vitamin D, Vitamin B1, Vitamin B2, Vitamin B3, and Vitamin B6.

3. The method of claim 1, wherein said plurality of minerals are selected from a group consisting of Calcium, Magnesium, Iron, and Potassium.

4. The method of claim 1, wherein said orally administering step can be accomplished via mixing with cat food.

5. The method of claim 1, wherein said orally administering step can be accomplished via mixing with water.

6. The method of claim 1, wherein said orally administering step can be accomplished via independent administration.

7. A cat supplement composition for improving a cat's overall health and wellbeing, comprising:
effective amounts of a plurality of vitamins;
effective amounts of a plurality of minerals;
an effective amount of fish broth;
wherein said effective amount of vitamins and said effective amount of minerals are mixed with said effective amount of fish broth to form a cat supplement mixture.

8. The cat supplement composition of claim 7, wherein said plurality of vitamins are selected from a group consisting of effective amounts of Vitamin A, Vitamin D, Vitamin B1, Vitamin B2, Vitamin B3, and Vitamin B6.

9. The cat supplement composition of claim 7, wherein said plurality of minerals are selected from a group consisting of effective amounts of Calcium, Magnesium, Iron, and Potassium.
